(19) United States
(12) Patent Application Publication
(10) Pub. No.: US 2006/0088446 A1
(43) Pub. Date: Apr. 27, 2006

(54) Pierceable, flexible device for covering containers for liquids

(75) Inventors: Michael Heck, Kirchhain (DE); Michael Slama, Marburg (DE); Norbert Zander, Marburg (DE)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: DADE BEHRING MARBURG GmbH

(21) Appl. No.: 11/258,153

(22) Filed: Oct. 26, 2005

(30) Foreign Application Priority Data
Oct. 26, 2004 (DE) 10 2004 052 082.8

(51) Int. Cl. B01L 3/00

(52) U.S. Cl. 422/99; 422/101

(57) ABSTRACT

The invention relates to a flexible device for covering containers for liquids, which device can be pierced by the action of a rod-shaped object and, after removal of the rod-shaped object, returns again to its original shape.

The invention relates to a flexible device for covering containers for liquids, which device can be pierced by the action of a rod-shaped object and, after removal of the rod-shaped object, returns again to its original shape.

In the field of modern diagnostics, a great many appliances are used which perform the necessary process steps, for example pipetting, mixing, incubating, centrifuging, measuring, etc., fully automatically. The samples analyzed with the aid of such appliances are in most cases human or animal body fluids or other analyte-containing liquids to which at least one test reagent often has to be added. The storage, removal, transfer and addition of liquids, which may be held in a very wide variety of containers, are therefore important operations within diagnostic appliances.

A criterion to be taken into consideration when establishing tests on fully automatic diagnostic appliances is the stability of the reagents when stored in the appliance, their so-called on-board stability, which is critically influenced by the conditions within the appliance. A particular problem is that of the evaporation-related loss of mass of liquid reagents. For standardized and reliable determination of analytes, it is imperative to use reagents of a defined composition, with the consequence that any changes in concentration caused by losses of liquid may impair the quality or so-called performance of the entire test. The reason behind the evaporation of liquid reagents is that they have to be directly accessible to the automatic pipettors and, therefore, are in general not hermetically sealed.

Depending on the construction of the appliances and pipettors, various precautionary measures are taken, as is known, in order to reduce the evaporation of liquids from the reagent containers. For example, many diagnostic appliances have cooled holders or positions in which the reagent containers are fitted. By cooling the reagents, the loss of liquid through evaporation can be substantially reduced. Another measure taken to minimize the effects of evaporation is that of reducing the cross section of the opening of the reagent container, although this cross section can be adapted only to a certain extent, limited by the dimensions of the pipettor. It is likewise customary to use stoppers or closure caps providing a greater or lesser degree of hermetic sealing.

A particularly impervious protection against evaporation is provided by closure caps which hermetically seal off the opening of the reagent container, for example rotary-closure elements or snap-fit closure elements. However, this kind of protection against evaporation is only suitable for appliances which also have a suitable device permitting opening and reclosing automatically.

The use of closure stoppers preferably made from highly elastic materials, for example rubber, is also wide spread. Examples of devices of this kind are to be found in EP 0 509 281 B1, EP 0 097 591 B1 and FR 2 772 727 A1. The advantage of these flexible closure stoppers is that they have admission openings for cannulas and other rod-shaped objects, which openings, as a result of the elasticity of the material used, have a certain flexibility. In this way, the admission openings can adapt to the diameter of the inserted object and can close again after the object has been removed. However, difficulties arise if, for example, pipettors need to be used which have a diameter only slightly smaller than the diameter of the opening of the reagent container. In these cases, either the admission opening has to be enlarged to such an extent that effective protection against evaporation is no longer guaranteed, or the pipettor has to be driven with considerable force through a narrow admission opening, which may necessitate technical modification of the entire appliance and, because of the friction that arises, also results in increased wear. An additional factor is that, because they protrude partially into the neck of the reagent vessel, closure stoppers of this kind have to be produced specifically for each particular shape of reagent container opening, and that a prefabricated admission opening is suitable only for a limited selection of pipetting devices, specifically those of similar diameter.

The object of the present invention was therefore to make available a device for closure of containers for liquids, which device is characterized in that, first, it contributes to reducing the effects of evaporation and thus to ensuring improved on-board stability of liquid reagents, secondly it can be used almost universally for: a very great variety of liquid containers and pipetting devices -in diagnostic appliances, without the need to modify the design of the liquid containers themselves or even of the appliances, and, thirdly, it represents a cost-effective alternative to the previously known closure devices.

The solution according to the invention lies in the provision of the subjects and methods described in the claims.

The present device for covering containers for liquids is preferably used for covering reagent containers used in appliances which perform process steps, for example pipetting or mixing of liquids, automatically. The device is composed of a membrane, that is to say a separating layer which is suitable for separation of two subsidiary areas or compartments. The membrane is provided with at least two incisions arranged in a radiating formation and is preferably placed on an opening of a container for liquids, so that the opening of said container is completely covered. In connection with the present invention, the term “incision” is to be understood as a cut extending completely through the membrane, i.e. through its entire thickness.

The membrane can be applied with the aid of chemical or mechanical coupling agents which produce a sealing and fixed connection between the membrane and that edge of the liquid container delimiting the opening. Within the meaning of the present invention, chemical adhesion is to be understood as adhesion produced with the aid of adhesives, preferably with the aid of liquid adhesives, between two joined parts, whereas mechanical adhesion is to be understood as adhesion which is influenced by the properties of surfaces, for example the-microscopic intermeshing of porous or fibrous surfaces, e.g. velcro-type closures.

A preferred variant is the use of a self-adhesive membrane which, on one side, at least in the area to be brought into direct contact with the container for liquids, is treated with an adhesive, for example as is known from commercially available self-adhesive films or adhesive labels. This embodiment has the advantage that the self-adhesive membranes can be applied on a support layer, for example a protective film, from which they can be easily detached without losing their adhesive force. To permit easier handling of the membranes and, for example, to make it easier to detach self-adhesive membranes from a support layer or apply them to a container for liquids, the device according to the invention can also be provided with one or more tear-off tabs.

Another way of applying the membrane is to use a screw-on cap which mechanically fixes the membrane on the edge delimiting the opening of a container for liquids. Screw-on caps within the meaning of the present invention have a preferably circular opening whose cross section permits the passage of the rod-shaped object to be used. The use of holed screw caps of this kind is particularly advantageous provided that the liquid container to be closed has a screw thread. It is also possible to adhesively bond the membrane and additionally fix it with the aid of a screw-on cap in order to achieve particularly stable securing, as a result of which it is possible to avoid the membrane becoming detached because of friction.

It may also be advantageous for the device according to the invention to be secured not on the edge of the liquid container itself, but instead on the edge of the screw-on cap. It is possible to place the device both on the outer edge and also on the edge directed toward the inside of the screw-on cap.

The device according to the invention for covering containers for liquids is composed of a flexible membrane provided with at least two incisions which meet at a common starting point or apex, that is to say are arranged in a radiating formation.

In a membrane provided with two incisions, said two incisions are arranged in such a way that an angle of 10° to 180°, preferably of 20° to 120°, particularly preferably of 45° to 90°, is formed.

Depending on the diameter of the rod-shaped object and the strength or elasticity of the membrane material used, the number of incisions and the angle spacings between the incisions can be varied so as to give an optimal ratio between passage width, minimal frictional resistance, and greatest possible protection against evaporation.

Another preferred embodiment of the device according to the invention is composed of a membrane provided with 3 to 12, preferably with 4 to 10, particularly preferably with 6 incisions, which are advantageously of equal length. It is also possible, however, for not all the incisions to be of equal length, and instead, for example, for a lengthening of some incisions in a certain area to permit the passage of an asymmetrically widened object.

An incision can be made by means of a straight, undulated or zigzag-shaped cut. The incisions are preferably arranged at equal angles to one another, such that several isosceles triangles are formed whose bases are connected to the circumferential edge of the membrane. The length of the incisions issuing from the apex can be varied and is preferably chosen so as to permit passage of that area of the rod-shaped object which has the greatest diameter and which is intended to pierce the cover device.

The device according to the invention can be pierced by the action of a rod-shaped object and, after removal of the rod-shaped object, returns again to its original shape. Under the action of a pipettor, for example, the free ends of the triangles which are cut into the membrane are forced into the interior of the container for liquids, as a result of which an opening is created which adapts flexibly to the diameter of the pipettor, i.e. with minimal friction. After the pipettor has been removed, the membrane triangles again assume their original position on account of the elasticity of the material used, and they thus close the opening of the container for liquids. This procedure can be repeated many times.

Rod-shaped objects within the meaning of the present invention are, for example, devices for transfer of liquids, such as pipettors or cannulas, or devices for mixing of liquids, for example stirring rods, and they are generally cylindrical or conical. The end of these rod-shaped objects can be pointed, rounded or blunt.

The flexible membrane is preferably made of an elastic, vapor-tight material. When selecting the material of the membrane, the skilled person should of course take into account that, for covering liquid containers that may contain such different liquids as aqueous solutions or organic solvents for example, a suitable membrane material must be used which is not adversely affected by the liquid to be covered or by the vapors of said liquid. The membrane is particularly preferably made of a material from the group comprising polyethylene (PE), polypropylene (PP), polyethylene terephthalate (PET), polystyrene (PS), polyamide (PA), polybutylene terephthalate (PBT), polycarbonate (PC), polyimides (PI), natural rubber, silicone rubber, bromobutyl rubber and chlorobutyl rubber. Membranes made from mixtures of these materials or from at least two different layers of these materials are likewise suitable. It is also possible, for example, to combine a cellulose layer with a layer of elastic material.

The thickness of the flexible membrane is preferably not greater than 150 μm and is advantageously between 40 μm and 100 μm, particularly preferably between 50 μm and 80 μm

A further particular embodiment of the device according to the invention is characterized by the fact that a circular, oval or polygonal opening, which may be punched out for example, is situated at the apex of the radiating incisions. The diameter of this opening advantageously corresponds to the diameter of that part of the rod-shaped object which passes through the closure device first upon admission into the liquid container and passes through the closure device last on being withdrawn, so that, for example, liquid residues attached to the outside of a pipettor are stripped off at the membrane. In this way, it is possible to avoid excessive contamination of the closure device, which reduces the risk of mixing together of different reagents, for example.

### FIGURES

FIG. 1 shows, in plan views, various embodiments of the device according to the invention for covering containers for liquids. The device is composed of an elastic membrane (1) provided with at least two incisions (2) which are arranged in a radiating formation.

FIG. 1a and FIG. 1b show devices according to the invention which are provided in each case with six incisions (2). The arrangement of the incisions at equal angles results in each case in six isosceles triangles (3) whose bases are connected to the circumferential edge of the membrane. The device in FIG. 1b has a circular opening (4) at the apex of the radiating incisions. The devices in FIG. 1a and FIG. 1b are in each case provided with three tear-off tabs (5) which are obtained by suitable cutting of the membrane and which make the devices easier to handle.

FIG. 1c shows a device according to the invention provided with two incisions which are arranged in such a way that they form an angle (6) of approximately 70°. FIG. 1d shows a device according to the invention which is provided with six incisions, said incisions not all being equal in length. The shape or contour of the devices is adapted to the shape of the opening that is to be covered on the container for liquid. Whereas the devices in FIGS. 1a to 1c are suitable in particular for covering circular openings, a device with a configuration as shown in

FIG. 1d can be used to cover oval openings. FIG. 1d also shows that the area of the membrane rendered pierceable, by the incisions does not have to lie at the center of the device, but can instead also be located somewhere other than at the central position.

FIG. 2 shows the application of a device according to the invention for covering containers (7) for liquids, which containers in this example are equipped with a screw thread (8) and for which a holed screw cap (9) with a central, circular opening is made available.

FIG. 2a shows that the device according to the invention can be fitted directly onto the edge (10) delimiting the opening of the container for liquid. The membrane can be fixed by coupling agents, for example an adhesive on the contact face, by mechanical securing through screwing-on of the screw cap, or by a combination of both of these.

FIG. 2b shows that the cover device according to the invention can also be fitted onto the outside of the edge delimiting the opening of the screw cap, the membrane in this case preferably being secured with the aid of a coupling agent.

FIG. 3 illustrates the usefulness of a device (1) according to the invention which in this case is composed of an elastic membrane provided with six incisions and is fitted on the opening of a screw-on cap (11) which is again placed on the opening of a container (12) for liquid. The filling level of the liquid in the inside of the container is indicated by a broken line.

FIG. 3a shows how a pipettor (13), which has areas of different diameter along its longitudinal axis, pierces the device according to the invention with the tip, i.e. with the area of least diameter (14).

FIG. 3b and FIG. 3c show how, by means of the increasing external diameter (15, 16) of the pipettor, the free ends of the membrane triangle (3) are forced into the interior of the container, as a result of which the opening adapts flexibly to the respective external diameter of the pipettor.

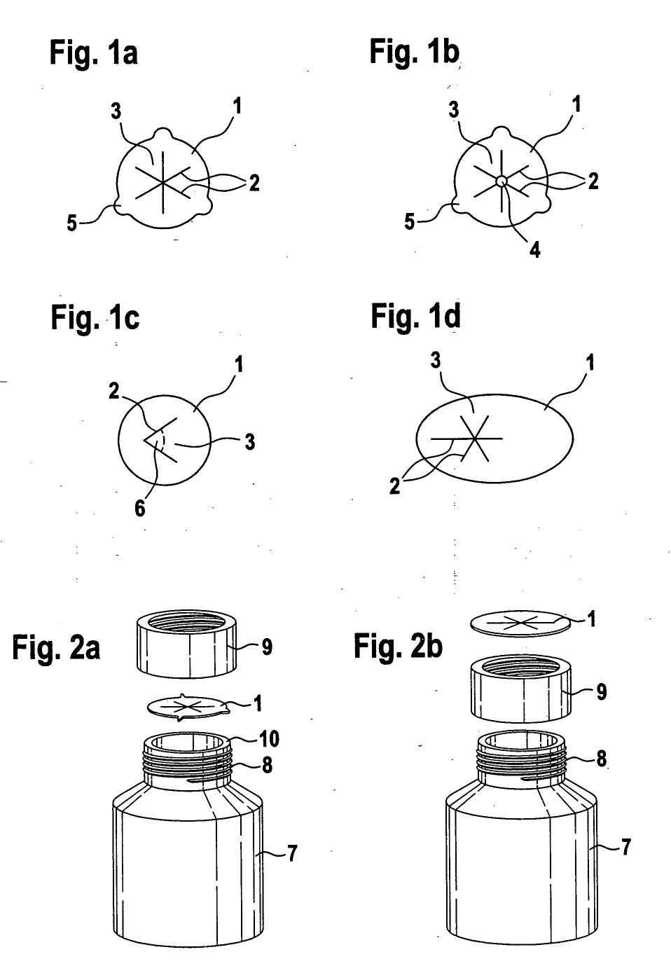

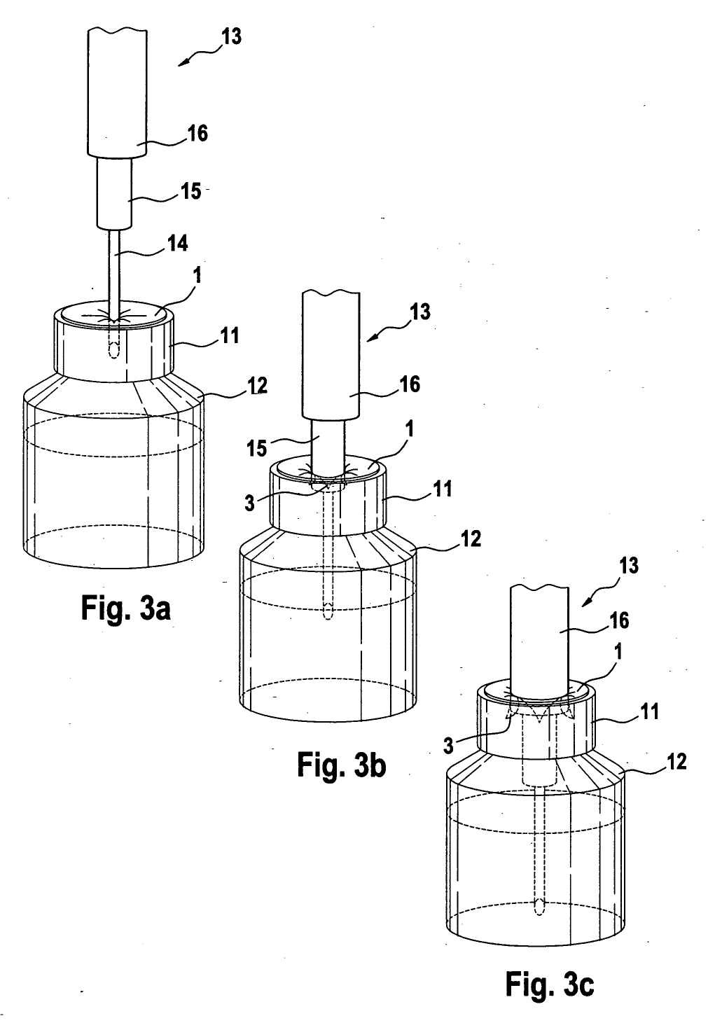

The examples described below are intended to illustrate individual aspects of this invention are not to be understood as limiting the latter.

### EXAMPLES

### Example 1

### Reduction of Evaporation-Related Weight Losses

Comparative tests were carried out on the basis of three reagents which can be used for a turbidimetric test method for quantitative determination of crosslinked fibrin derivatives which contain the D-dimer domain (hereinafter called D-dimer for short). All three reagents were aqueous solutions which were mixed with a plasma sample for carrying out the test. While reagent B was a suspension of latex particles coated with a D-dimer-specific monoclonal antibody (see EP 0 122 478 B2 for example), reagents A and C were essentially buffered saline solutions. When D-dimer is present in a plasma sample, agglutination of the latex particles takes place and this can be quantified on the basis of the turbidity. This test method was established on the automatic coagulation analyzer Sysmex® CA-560 (Dade Behring Marburg GmbH, Marburg, Germany) for automatic operation.

The Sysmex® CA-560 analyzer (CA-560 for short) has a temperature-controllable position (15±1° C.) for one test reagent container, and further positions for reagent containers whose temperature cannot be regulated and accordingly correspond to the room temperature (ca. 15 to 25° C.). Test reagent A was placed in the temperature-controlled position, while test reagents B and C were placed in positions without temperature control. The reagent containers were screw-neck vials made of glass, with a capacity of 5 ml and a diameter of their opening of approximately 11 mm.

At the time t(0), the reagent containers A, B and C were opened and placed in the allocated positions of the CA-560, either with or without use of a cover device according to the invention. In the present test, a self-adhesive polypropylene membrane was used which was coated on one side with cellulose and was treated on the other side with an adhesive, resulting in an overall film thickness of 62 μm and a weight of 93 g/m². The membranes were cut out in circles from a blank, had a diameter of approximately 12 mm and were provided with 8 radial incisions of equal length arranged at equal angles to one another. The membranes were adhesively bonded onto the upper edges of the reagent containers and additionally stabilized with a holed screw cap, as is shown also in FIG. 2a.

Each of the reagent containers held 2 ml of reagent liquid at the time t(0). The mass of the filled reagent containers was determined at time t(0) and after 18 hours, at time t(18). The relative loss of mass of the reagent liquids was determined from the difference (Δ) between the mass at time t(0) and the mass at time t(18).

From the results, which are compiled in Table 1, it is evident that, by using a device according to the invention for covering the reagent containers, evaporation-related losses of mass can be reduced by 30 to 50%.

TABLE 1

| | without cover device | | | with cover device | | |
|---|---|---|---|---|---|---|
| | Mass m [g] | | ΔMass m [g] | Mass m [g] | | ΔMass m [g] |
| | t(0) | t(18) | m(t(0))-m(t(18)) | t(0) | t(18) | m(t(0))-m(t(18)) |
| Reagent A | | | | | | |
| (15 ± 1° C.) | 11.69915 | 11.63680 | 0.06235 | 11.80095 | 11.77415 | 0.02680 |
| Rel. loss of mass [%] | | | 3.1% | | | 1.3% |
| Reagent B | | | | | | |
| RT (15 to 25° C.) | 11.59556 | 11.43339 | 0.16217 | 11.98514 | 11.91008 | 0.07506 |
| Rel. loss of mass [%] | | | 8.1% | | | 3.8% |
| Reagent C | | | | | | |
| RT (15 to 25° C.) | 11.62326 | 11.49052 | 0.13274 | 11.76849 | 11.68306 | 0.08543 |
| Rel. loss of mass [%] | | | 6.6% | | | 4.3% |

### Example 2

### Increasing the On-Board Stability

To investigate on-board stability, the test reagents A, B and C, suitable for quantitative determination of D-dimer, were again placed in the allocated positions of the CA-560 (see Example 1), and different test series were conducted under the following test conditions:
1) The three reagent containers were manually opened only for the duration of the test procedure and, until the next cycle, were stored closed with an integral stopper and a screw cap.
2) The three reagent containers were stored open throughout the entire test period.
3) The three reagent containers which contained the test reagents were provided with a closure device according to the invention as described in Example 1.

The reagent containers, which each held 2 ml of reagent liquid, were opened for the first time at time t(0) and were introduced into the CA-560, and, at time t(0), a test for quantitative determination of D-dimer was carried out in a plasma sample of low D-dimer concentration (LOW control) and in a plasma sample of high D-dimer concentration (HIGH control). For each sample, a raw value (mOD/min) was measured, on the basis of which it was possible to determine the D-dimer concentration of the measured sample using a previously established calibration curve. The raw value determined at time t(0) served subsequently as a reference value for the performance of the test. The reagents were stored in the appliances under the conditions described at 1), 2) or 3) and, after 18 hours, a further test cycle was conducted with the same samples. The relative deviations of the raw values at time t(18) from the corresponding reference values at time t(0) were determined, as also were the relative deviations of the D-dimer concentration which had been determined on the basis of the raw values.

Table 2 shows the results from these tests on on-board stability.

TABLE 2

| | | | | Stored with |
|---|---|---|---|---|
| | Reference | Stored | Stored | cover |
| | at t(0) | closed | open | device |
| | Time t[h] | | | |
| | 0 | 18 | 18 | 18 |
| Control LOW | | | | |
| Raw values | 17.2 | 16.2 | 18.9 | 17.5 |
| Signal | | | | |
| [mOD/min] | | | | |
| Relative | | −5.8% | 9.9% | 1.7% |
| deviation [%] | | | | |
| D-dimer | 416 | 397 | 447 | 422 |
| concentration | | | | |
| [μg/L] | | | | |
| Relative | | −4.6% | 7.5% | 1.4% |
| deviation [%] | | | | |
| Control HIGH | | | | |
| Raw values | 152.9 | 153.7 | 165.2 | 149.2 |
| Signal | | | | |
| [mOD/min] | | | | |
| Relative | | 0.5% | 8.0% | −2.4% |
| deviation [%] | | | | |
| D-dimer | 3638 | 3673 | 4200 | 3476 |
| concentration | | | | |
| [μg/L] | | | | |
| Relative | | 1.0% | 15.4% | −4.5% |
| deviation [%] | | | | |

As will be seen from Table 2, the use of the cover device according to the invention also affords better on-board stability of the entire test. Compared with the measured raw values and the determined D-dimer concentrations which were obtained after 18 hours with the aid of the reagents stored open, the deviation of the test results obtained with the reagents which were covered over the 18-hour storage period with a device according to the invention is considerably lower. On account of the better test accuracy (performance) obtained after 18 hours of storage of the test reagents in the appliances (on-board), the use of the cover device according to the invention is preferable to open storage of the test reagents.

1-18. (canceled)

19. A device fir preventing evaporation from a container, comprising:
an elastic membrane configured to cover the container containing a liquid,
wherein the elastic membrane includes at least two incisions disposed in a radiating formation,
wherein the elastic membrane is pierceable by a rod-shaped object, and
wherein upon the removal of the rod-shaped object, the elastic membrane is configured to return to its original configuration.

20. The device of claim 19, wherein the elastic membrane includes between three and twelve incisions.

21. The device of claim 20, wherein the elastic membrane includes between four an ten incisions.

22. The device of claim 21, wherein the elastic membrane includes six incisions.

23. The device of claim 19, wherein the at least two incisions are disposed at equal angles to each other.

24. The device of claim 19, wherein the elastic membrane includes an opening disposed at an apex of the radiating formation,
wherein the opening includes a circular shape or a polygonal shape.

25. The device of claim 19, wherein the at least two incisions form an angle,
wherein the angle is between about 10 degrees and about 180 degrees.

26. The device of claim 25, wherein the angle is between about 20 degrees and about 120 degrees.

27. The device of claim 26, wherein the angle is between about 45 degrees and about 90 degrees.

28. The device of claim 19, wherein each of the at least two incisions have the same length.

29. The device of claim 19, wherein at least two of the at least two incisions have different lengths.

30. The device of claim 19, further comprising a container configured to contain liquid,
wherein the container includes an opening, and
wherein the elastic membrane is disposed over the opening.

31. The device of claim 30, wherein the opening is defined by an edge, and
wherein the elastic membrane is fixed to the edge by mechanical adhesion or chemical adhesion.

32. The device of claim 30, further comprising a screw-on cap including a substantially circular opening configured to accommodate the passage of a rod-shaped object through the opening,
wherein the elastic membrane is fixed to the container via the screw-on cap.

33. The device of claim 19, wherein the elastic membrane has a thickness of between about 40 micrometers and about 150 micrometers.

34. The device of claim 33, wherein the elastic membrane has a thickness of between about 40 micrometers and about 100 micrometers.

35. The device of claim 34, wherein the elastic membrane has a thickness of between about 50 micrometers and about 80 micrometers.

36. The device of claim 19, wherein the elastic membrane is made out of a vapor-tight material.

37. The device of claim 19, wherein the elastic membrane is made of at least one of the following materials: polyethylene, polypropylene, polyethylene terethalate, polystyrene, polyamide, polybutylene terephthalate, polycarbonate, polyimides, natural rubber, silicone rubber, bromobutyl rubber, and chlorobutyl rubber.

38. The device of claim 19, wherein the elastic membrane includes at least two layers.

39. The device of claim 38, wherein one of the at least two layers is made from a first material and the other of the at least two layers is made of a second material different from the first material.

40. The device of claim 19, wherein one side of the elastic membrane includes a self-adhesive surface.

41. The device of claim 19, wherein the container is a reagent container.

42. The device of claim 19, further comprising a reagent container including an opening,
wherein the elastic membrane is disposed over the opening.

43. A device for preventing evaporation from a container, comprising:
an elastic membrane configured to cover the container;
at least two incisions in the elastic membrane configured to permit access to an interior of the container by a rod-shaped object and configured to prevent evaporation from the container upon removal of the rod-shaped object;
wherein the at least two incisions radiate from an apex.

44. A device for preventing evaporation from a container, comprising:
an elastic membrane configured to cover the container to prevent evaporation from the container;
at least two incisions in the elastic membrane, the at least two incisions radiating from an apex in the elastic membrane;
wherein the at least two incisions are configured to permit a portion of the elastic membrane to open upon piercing by a rod-shaped object, and
wherein the at least two incisions are configured to close upon removal of the rod-shaped object.
